(19) United States
(12) Patent Application Publication
(10) Pub. No.: US 2011/0079197 A1
(43) Pub. Date: Apr. 7, 2011

(54) Control Method and Apparatus for Multi-Fuel Compression Ignition Engines

(75) Inventors: Jeffrey Stewart, Woodland Park, CO (US); Daniel Donald Giordano, Colorado Springs, CO (US); Evelyn Vance, Woodland Park, CO (US)

(73) Assignee: STURMAN INDUSTRIES, INC., Woodland Park, CO (US)

(21) Appl. No.: 12/895,376

(22) Filed: Sep. 30, 2010

Related U.S. Application Data
(60) Provisional application No. 61/247,880, filed on Oct. 1, 2009.

(51) Int. Cl. F02D 11/10

(52) U.S. Cl. 123/399

(57) ABSTRACT

Control method and apparatus for multi-fuel, compression ignition engines. In accordance with the method, a target fuel whose engine operating characteristics are to be duplicated when using fuels other than the target fuel in the engine is selected, and the engine operating characteristics including engine torque versus throttle setting and engine RPM when operating using the target fuel are determined and stored as a desired indicated torque versus throttle setting and engine RPM. Then, when the engine is operating on a fuel, a fuel control input and engine RPM are sensed, the desired indicated torque for that fuel control input and engine RPM is determined, a measured indicated torque for the engine is determined, and a fuel quantity command is adjusted to cause the measured indicated torque to equal the desired indicated torque.

### CROSS-REFERENCE TO RELATED APPLICATION

This application claims the benefit of U.S. Provisional Patent Application No. 61/247,880 filed Oct. 1, 2009.

### STATEMENT OF GOVERNMENT INTEREST

The U.S. Government has certain rights in this invention pursuant to TACOM LCMC Contract No. W56HZV-07-C-0528 awarded by the U.S. Army.

### BACKGROUND OF THE INVENTION

1. Field of the Invention

The present invention relates to the field of compression ignition engines and, more particularly, to the field of compression ignition engines for operation on multiple fuels.

2. Prior Art

Compression ignition engines have characteristically been designed to operate on some pre-determined fuel by far the most common of which has been diesel fuel. More recently, bio-diesel fuels have been introduced; however, bio-diesel fuels have had a hard time breaking into the market because the requirements for conventional engines are so strict that the fuel must be chemically very close to standard diesel. A multi-fuel capable engine like the present engine would not have such strict requirements, therefore opening the door to a variety of bio-diesel fuels that are close to, but not precisely, diesel.

In addition, there is an increasing interest in being able to operate a diesel engine on still additional fuels such as JET-A, JP-8, kerosene and ordinary heating oil (which may or may not be very similar to diesel No. 2 fuel oil) to name but a few of the possibilities. In general, a conventional compression ignition engine will run on any of these fuels provided the compression ratio is high enough to ensure ignition of the fuel but subject to at least two important limitations: The first limitation is the inability to attain the best efficiency for each fuel because differences in ignition delays and combustion rates cause an engine calibrated to run most efficiently on one fuel to not run efficiently on another fuel. The second limitation with running a conventional compression ignition engine on different fuels is the engine response. Particularly in vehicles, though in many other applications as well, it is desirable that the engine's response to the accelerator (throttle) be independent of the particular fuel being used at the time. While different fuels may have different maximum power outputs for a given engine, below maximum power, a conventional engine will also respond differently for different fuels being responsive to power setting (accelerator setting in vehicles) for one fuel and giving the feeling of lack of response for another fuel.

A control system for controlling spark ignition engines is disclosed in U.S. Pat. No. 6,457,463. That system uses fuel injection and adjusts fuel injection angle, fuel quantity, spark timing and spark duration based on various inputs including sensors, speed (RPM), throttle position (load) and a “map selector switch”, which selects between look-up tables to provide the proper look-up table for the particular fuel being used. Since it is a spark ignition engine and throttle position controls the amount of air ingested into the engine, the fuel quantity injected must be controlled responsive to the throttle position resulting in the engine responding differently to throttle position for different fuels. Also in the system of the '463 patent, fixed look-up tables are used which must be selected by the engine user in accordance with the fuel then actually being used. This system does not appear to have the capability to mix fuels, such as will occur when a partially full fuel tank at any level is filled with a different fuel.

### BRIEF DESCRIPTION OF THE DRAWINGS

FIG. 1 is a block diagram illustrating the control of a compression ignition engine in accordance with one embodiment of the present invention.

FIG. 2 is a block diagram illustrating the application of the control of FIG. 1 in an engine system.

### DETAILED DESCRIPTION OF THE PREFERRED EMBODIMENTS

There are many applications wherein it may be desirable to operate a compression ignition engine on any of multiple fuels or on mixtures thereof. Such incentives may include, by way of example, availability or relative price. Further, there may be applications wherein other equipment operates on a fuel other than regular diesel fuel used in conventional compression ignition engines. The ability to operate a compression ignition engine on the other fuel when required or desired can result in a substantial savings in comparison to having to provide a supply of a second fuel simply for a compression ignition engine.

Compression ignition engines will operate on different fuels, providing the compression ratio is sufficiently high to ignite the different fuels used, though, in general, will be calibrated for best performance on a single fuel. Also, the different fuels can result in very different engine response characteristics, which, in a vehicle, can be very distracting to the vehicle operator and can even be dangerous.

Accordingly, one of the many objectives of the present invention is to provide uniform engine performance, independent of the fuel being used, so that the engine response is constant and repeatable independent of the fuel.

Of course, for a given engine, there can be differences in the maximum power output for different fuels, though with the present invention, performance of the engine up to that maximum output will be constant independent of the fuel, and of course, independent of the mixture of fuels as will occur when a fuel tank having some amount of a first fuel therein is refilled with a second fuel whether the two fuels are mixed well or not.

In the present invention, the target fuel, that is, the fuel the performance of which is to be simulated with other fuels or mixtures thereof, may be a commonly used fuel such as diesel number 2, or alternatively, may be a synthesized performance not really characteristic of any specific existing fuel.

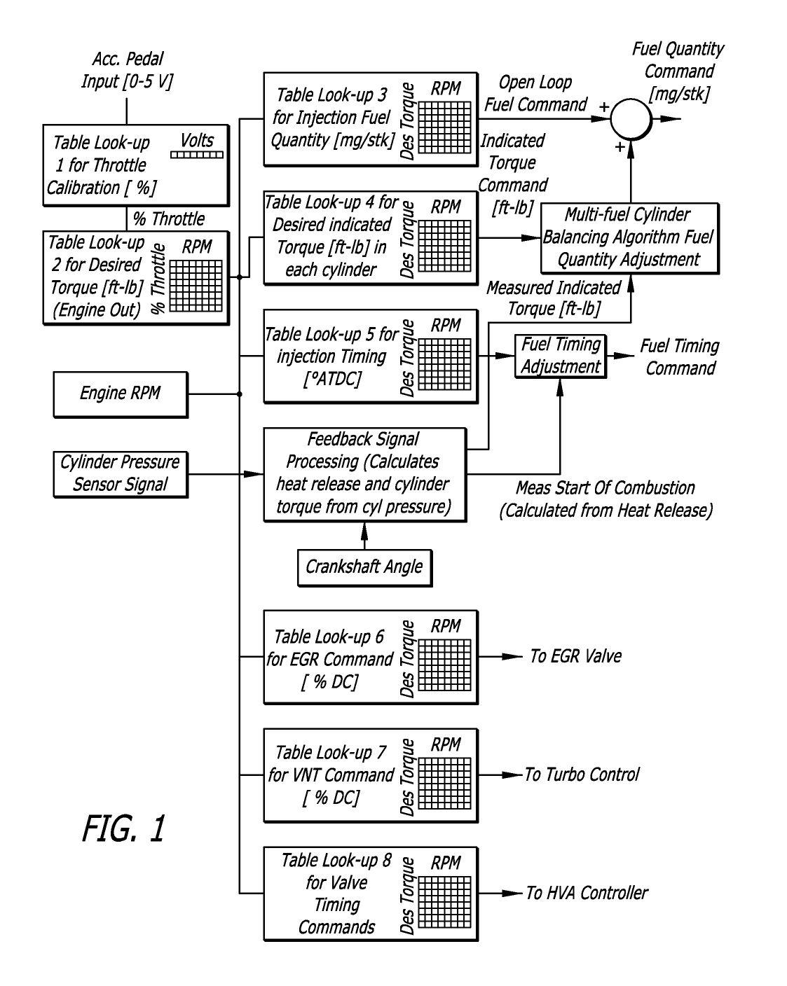

First referring to FIG. 1, a block diagram of one embodiment of the present invention may be seen. This embodiment is used on an electronically controlled engine having a hydraulic valve actuation system (HVA). The use of a hydraulic or other non-mechanical valve actuation system allows greater flexibility in the engine operation. However, the present invention may be used in engines with mechanical valve actuation, though electronic control of the fuel injectors, at least, is required. It is also assumed in the description of this embodiment that the engine is used in a vehicle controlled by an accelerator pedal, but this is not a limitation of the invention. In that regard, the words throttle and accelerator are used in a most general sense herein to mean some form of typically, but not necessarily, a mechanical power setting control, whether the engine is in a vehicle or is used in some other application.

As shown in FIG. 1, the accelerator position (Acc. Pedal Input [0-5v]) is converted to a voltage and then converted to a digital value by an analog-to-digital converter (not shown). This digital value is used in Table Look-up 1 to convert the digital value to a throttle setting given as a percentage of full throttle. This Table Look-up allows for non-linearity in the accelerator pedal position versus the percentage of full throttle that that accelerator pedal position would provide on the target engine (the actual engine in the actual vehicle). The percentage throttle setting is then used as one input to Table Look-up 2, with Engine RPM being the second input, to provide the Desired Torque for the target fuel (the fuel which the engine performance is to simulate). Table Look-up 2 has Desired Torque values for various RPM and percent throttle settings. In use, the closest values for the actual RPM and percent throttle setting are used with interpolation between values in both directions. This general type of Table Look-up is also used for Table Look-ups 3-8.

The Desired Torque from Table Look-up 2 in the engine of this embodiment is used together with the engine speed in RPM for access to Table look-ups 3-8. The first of these Table Look-ups, namely Table Look-Up 3, converts the Desired Torque to an Injection Fuel Quantity (Open Loop Fuel Commands) applicable to all cylinders. This value may be based on the assumption that one particular fuel is being used, or even a fictitious fuel, though likely would be based on the most common fuel used with the engine to provide an Injection Fuel Quantity most likely to need minimal correction.

The Desired Torque is also used to access Table Look-Up 4 to convert the Desired Torque to a Desired Indicated Torque for each cylinder. Note that the Desired Indicated Torque for each cylinder is not simply the Desired Torque divided by the number of cylinders, but rather, will be higher as a function of the Desired Torque and Engine RPM because of energy expenditures and mechanical losses in the engine. From Table Look-Up 4, an Indicated Torque Command for each cylinder is obtained. This value is used together with a Measured Indicated Torque value in the Multi-fuel Cylinder Balancing Algorithm to provide a Fuel Quantity Adjustment to the Open Loop Fuel Command to obtain the final Fuel Quantity Command to the fuel injector controller to cause the Measured Indicated Torque to equal the Desired Indicated Torque. Note that the Measured Indicated Torque is a per cylinder value so that even though the Open Loop Fuel Command is the same for all cylinders, the adjustment to obtain the final Fuel Quantity Command is a per cylinder adjustment based on the Measured Indicated Torque for that cylinder. The Measured Indicated Torque is a calculated value based on Cylinder Pressure and Crankshaft Angle. In addition, the Heat Release from fuel combustion is calculated for each cylinder based on Cylinder Pressure and Crankshaft Angle using compressible gas laws. The Heat Release is used to sense the start of combustion, i.e., combustion is considered to have started when the Heat Release reaches a predetermined threshold. This start of combustion measurement is used to adjust the Fuel Timing for the final Fuel Timing Command for each cylinder.

The foregoing provides not only an engine performance simulating the engine running on the target fuel but also includes adjustments for maximum efficiency by adjusting ignition, in the disclosed embodiment on a cylinder by cylinder basis, and further includes cylinder balancing. Note that while cylinder balancing as described herein is preferable, the present invention may be used without cylinder balancing, and thus, cylinder balancing is not a limitation of the invention.

In addition to the foregoing, in a preferred embodiment, Look-Up Tables 6, 7 and 8 provide open loop EGR (exhaust valve recirculation) Commands, Turbo Commands and HVA Timing Commands, respectively, each based on the Desired Torque and RPM of the engine. However, this invention could also be utilized to provide closed-loop control of these extra engine control commands.

Thus, it may be seen from FIG. 1 that an Open Loop Fuel Command is first determined for each combustion cycle of each cylinder, the Desired Indicated Torque Command is compared with the Measured Torque for that cylinder and adjustments in the fuel quantity command are made based on that difference. Consequently, an engine running at a given throttle setting will have the Open Loop Fuel Command applicable to all cylinders but then corrected for the actual

Measured Indicated Torque produced by that cylinder so that the Measured Indicated Torque for that cylinder will be corrected for the Indicated Torque Command. Thus, all cylinders of the engine will be balanced in terms of power output and will provide the Desired Torque for the accelerator pedal position and RPM independent of the fuel being used. Note that when the accelerator pedal position is changed, the Open Loop Fuel Command and the Fuel Quantity Command will change accordingly. Also, the Desired Indicated Torque Command will change a corresponding amount. The Measured Torque will also change because of the Fuel Quantity Command change; though assuming the fuel actually being used is not the target fuel, the change will probably not match the Indicated Torque Command, and accordingly, the Multi-fuel Cylinder Balancing Algorithm will make a correction to the Fuel Quantity Command for each cylinder so that the Measured Torque equals the Indicated Torque Command. Note that the amount of correction needed for any accelerator pedal position change will depend on the extent of accelerator position change and the difference between the actual fuel being used and the target fuel. Consequently, while the change in the Open Loop Fuel Command for a given fuel to match a target fuel may be substantial, the changes in that correction for normal driving will usually be much smaller. Also, with an engine turning at only 1800 RPM or 30 revolutions per second in a four stroke cycle, most of the adjustment in the correction can be made in three power strokes, or approximately two tenths of a second, a relatively unnoticeable time period considering the substantially longer human reaction time. At higher engine speeds, the time delay will be even shorter.

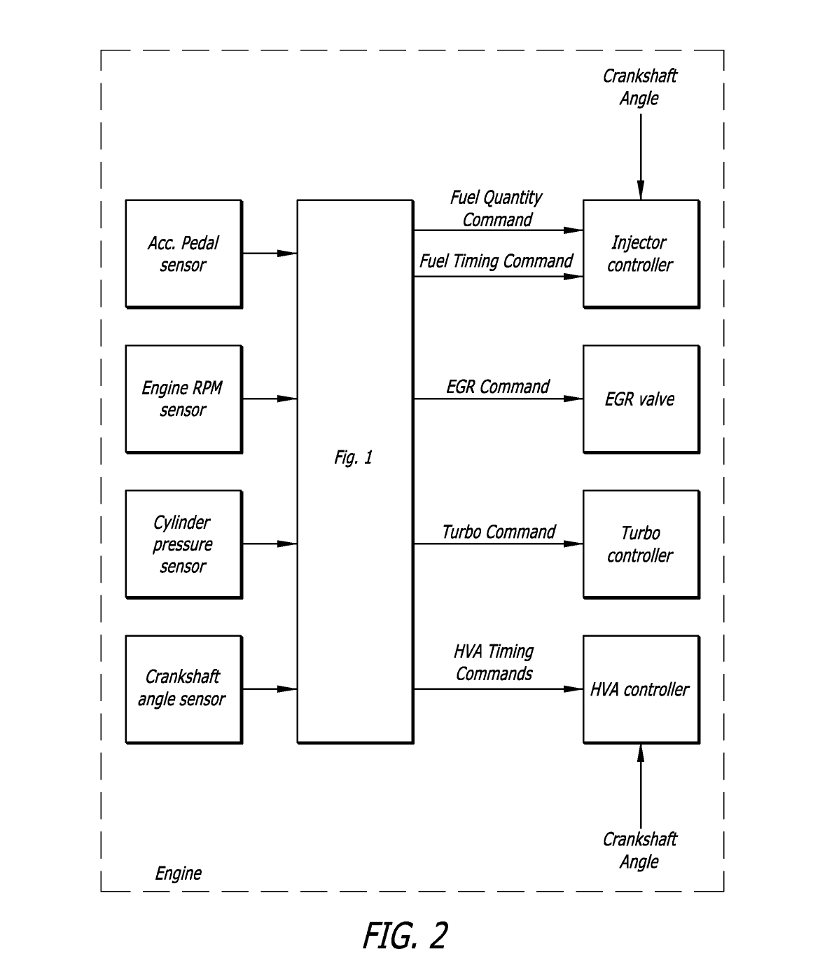

The system of FIG. 1 would typically be realized in firmware on a micro-processor based controller. An overall engine system incorporating the present invention may be seen in FIG. 2. The system of FIG. 1 requires an input of Accelerator Pedal Position, which may be by way of a variable resistance, though other position sensing devices, such as non-contact devices (electromagnetic, capacitive, etc.) may also be used. It also requires inputs of Engine RPM, Cylinder Pressure and Crankshaft Angle. The Engine RPM input is used as one entry into Table Look-ups 2-8, as previously explained. Engine Cylinder Pressure sensors are commercially available, such as, by way of example, from companies like Kistler Instrument Corporation. The Crankshaft Position sensing and Engine RPM sensing may be done using separate sensors as shown in FIG. 2. In that Figure, the Crankshaft Position sensor and the Engine RPM sensor are shown as separate sensors in FIG. 2. The Crankshaft Position sensor, preferably, should sense crankshaft angular position to within approximately one degree while the Engine RPM sensor need only sense the Engine RPM to within something on the order of one or two percent. A suitable Crankshaft Position sensor may be, by way of example, an optical sensor sensing angular increments, together with a reference point for resetting the increment count to zero for each full rotation of the crankshaft. The Engine RPM sensor may be a separate speed sensor, or may derive the Engine RPM from information provided by the Crankshaft Position sensor.

The Fuel Quantity Command and Fuel Timing Command of FIG. 1 are provided to the Injector controller of FIG. 2, which also receives the Crankshaft Angle as an input. Similarly, the HVA Timing Command is provided to an HVA Controller which also receives the Crankshaft Angle as an input to control the Hydraulic Valve Actuation system. The EGR Command is provided to the EGR valve and the Turbo Command provided to the Turbo controller all as shown in FIG. 2. In one embodiment, the turbocharger is a variable vane type turbocharger.

In one embodiment, the various devices are electrically interconnected with a CAN bus now commonly used in the automotive field. The Fuel Timing Commands and the HVA Timing Commands may not necessarily convey the full Fuel Timing and HVA Timing information, but rather, may only convey adjustments to the fuel timing and HVA timing resident in the injector and HVA controllers. This reduces the information transfer needed and also provides a limp-home capability in the event of a system failure that interrupts the Fuel Timing Commands and the HVA Timing Commands of FIG. 1.

In some embodiments, cylinder balancing may not be used.

In this case, the difference between the Indicated Torque Command and an average Measured Torque would be used to make a “global” correction to the Open Loop Fuel Command for all cylinders. Also, if EGR, a turbocharger and/or some form of camless engine is not used, Table Look-ups 6, 7 and 8 are simply eliminated. Each Table Look-up, 3 through 8, if used, can be empirically determined for the engine running on the target fuel; however, as stated before, it is possible to make these parameters or look-up tables, or at least one or more of them, self-adapting based on feedback on engine performance on a fuel other than the target fuel. One potential feedback variable may be cylinder pressure, though typically with one or more other variables, such as, by way of example, crankshaft angle and engine RPM.

Note that in the foregoing, the desired torque is converted to a desired indicated torque (the desired torque as adjusted upward to account for energy expenditures and mechanical losses in the engine) and compared with a measured indicated torque that does not account for energy expenditures and mechanical losses in the engine, to provide a fuel quantity adjustment to the open loop fuel command. Alternatively, the desired indicated torque may be taken as equal to the desired torque and the measured indicated torque may be taken as an actually measured engine torque, or as a calculated torque, such as described herein, but adjusted downward to account for expected energy expenditures and mechanical losses in the engine. Thus, the end result is the adjustment of the fuel quantity to cause the measured indicated torque (based on some actual measure of the engine torque) to equal the desired indicated torque (based on a corresponding measure of engine torque versus fuel control setting and engine RPM when operating with the target fuel). Accordingly, when the engine is operating on a fuel other than the target fuel, the engine torque for various fuel control inputs and engine RPM will equal the engine torque for that fuel control input and engine RPM as if the engine is operating on the target fuel.

There has been described herein compression ignition engines with control systems that not only allow a compression ignition engine to operate on any one, or mixtures of, multiple fuels but to also operate efficiently, and provide the same performance, independent of the fuel being used (subject to limitations on maximum power outputs). Thus, the present invention has a number of aspects which aspects may be practiced alone or in various combinations or sub-combinations as desired. While a preferred embodiment of the present invention has been disclosed and described herein for purposes of illustration and not for purposes of limitation, it will be understood by those skilled in the art that various changes in form and detail may be made therein without departing from the spirit and scope of the invention.

What is claimed is:

1. A method of operating a compression ignition engine on different fuels at different times comprising:
selecting a target fuel whose engine operating characteristics are to be duplicated when using fuels other than the target fuel in the engine;
determining the engine operating characteristics, including a measure of engine torque versus throttle setting and engine RPM when operating with the target fuel, and storing a desired indicated torque versus throttle setting and engine RPM; and
when the engine is operating on a fuel;
sensing a fuel control input and engine RPM;
determining the desired indicated torque for that fuel control input and engine RPM;
determining a measured indicated torque for the engine; and
adjusting a fuel quantity command to cause the measured indicated torque to equal the desired indicated torque;
whereby when the engine is operating on a fuel other than the target fuel, the engine torque for various fuel control inputs and engine RPM will equal the engine torque for that fuel control input and engine RPM as if operating on the target fuel.

2. The method of claim 1 further comprising when the engine is operating on a fuel, determining
an open loop fuel command for that fuel control input and engine RPM;
sensing cylinder pressure and crankshaft angle and calculating a measured indicated torque.

3. The method of claim 2 wherein the engine operating characteristics are stored in look-up tables.

4. The method of claim 3 wherein in the case of look-up tables with two variables to find a third variable, interpolation between values in both directions is used.

5. The method of claim 2 wherein the desired indicated torque is determined from a look-up table using desired torque and engine RPM, where the desired torque is determined from the engine RPM and the fuel control.

6. The method of claim 5 wherein the engine is a camless engine having electronic controlled engine valves, and further comprising:
providing a control signal, determined from a look-up table using desired torque and engine RPM, to a valve actuation controller.

7. The method of claim 2 wherein in a multi-cylinder engine, the sensing of the cylinder pressure and crankshaft angle, the calculating of a measured indicated torque, and the adjusting of the open loop fuel command are done on a cylinder by cylinder basis.

8. The method of claim 2 further comprising determining injection timing from the engine RPM and making a fuel timing adjustment to provide a fuel timing command to an electronic fuel control based on a measured start of combustion determined, at least in part, from the sensed cylinder pressure.

9. The method of claim 8 wherein one or more parameters defining the operation of the engine on a fuel other than the target fuel are self adaptive based on feedback of one or more variables relating to engine performance.

10. The method of claim 8 wherein the measured start of combustion is determined from the cylinder pressure and crankshaft angle based in a calculated heat release using compressible gas laws.

11. The method of claim 8 wherein the injection timing is determined from the engine RPM using a look-up table.

12. The method of claim 2 further comprising providing an EGR valve control signal responsive to the desired indicated torque and engine RPM.

13. The method of claim 2 further comprising providing a turbocharger control signal responsive to the desired indicated torque and engine RPM.

14. The method of claim 2 wherein the engine has a hydraulic engine valve actuation system and further comprising providing a hydraulic engine valve actuation system control signal responsive to the desired indicated torque and engine RPM.
